(19) United States
(12) Patent Application Publication
(10) Pub. No.: US 2026/0211851 A1
(43) Pub. Date: Jul. 23, 2026

(54) REDUCING SUPPORT BUNDLE SIZES FOR CLUSTER FILESYSTEM BY PREDICTING PROBLEM AREAS

(71) Applicant: Dell Products L.P., Round Rock, TX (US)

(72) Inventors: Viral Mehta, Pune (IN); Rajat Patil, Latur (IN); Nihar Mukhiya, Mahad (IN)

(21) Appl. No.: 19/032,365

(22) Filed: Jan. 20, 2025

(51) Int. Cl. G06F 16/182; G06F 16/11; G06F 16/16

(52) U.S. Cl. CPC G06F 16/182; G06F 16/113; G06F 16/162

(57) ABSTRACT

Reducing the size of support bundles collected in a cluster filesystem by collecting log information for each node in a cluster system. User input regarding a problem is processed through Machine Language models as applied to components within the system. The models predict which component is the likely cause of the problem in terms of prediction confidence values. Prediction confidences are compared for each component at a level and if a component has a sufficiently high prediction confidence while all other components at that level have a sufficiently low prediction confidence, logs for that component are gathered to make the support bundle. Each level is processed in order of low to high until a single component is identified as being problematic.

### TECHNICAL FIELD

Embodiments are directed to distributed networks, and more specifically to collecting support bundles for cluster networks by predicting problem areas.

### BACKGROUND

A distributed (or cluster) file system is a type of file system in which data is spread across multiple storage devices as may be provided in a cluster of nodes. Cluster network systems represent a scale-out solution to single node systems by providing networked computers that work together so that they essentially form a single system. Each computer forms a node in the system and runs its own instance of an operating system. The cluster itself has each node set to perform the same task that is controlled and scheduled by software. In this type of network, the file system is shared by being simultaneously mounted on multiple servers. This type of distributed file system can present a global namespace to clients (nodes) in a cluster accessing the data so that files appear to be in the same central location. Such distributed file systems are typically very large and may contain many hundreds of thousands or even many millions of files, as well as services (applications) that use and produce data.

The Santorini file system represents a type of cluster network system that stores the file system metadata on a distributed key value store and the file data on object store. The file/namespace metadata can be accessed by any front end node, and any file can be opened for read/write by any front end node.

Because of their extensive scale and complex component features, cluster systems are typically provided by vendors and installed for use by customers (users). Consequently, vendors must be available to provide ongoing support, update, and debugging services to these users. Such support requires the transmission of information and data from the users back to the vendor so that specific problem areas can be identified and fixed, and general issue and feature trends can be recognized for ongoing and future product development. Such information can be provided in the form of “support bundles” that comprise relevant user and system information provided between the user and vendor.

Support bundle collection is thus a critical feature for scale-out cluster networks, such as Santorini, both at user sites and during development. When a user system experiences severe problems, the vendor must analyze a collected support bundle that has been transferred back to their facilities. Similarly, during development, engineers collect and analyze support bundles to understand problems in their code. Such a process involves much interface with and analysis of program code, which can be a timely and expensive process.

Support bundles are generally a collection of log files from all the components in a product. Bundles are generally created when an end-user (customer or system/integration test engineer) hits a problem that needs to be analyzed and fixed by a technical support engineer (TSE) or to be reported up to core product engineering teams. With a very large and complex product, a support bundle can contain hundreds to thousands of files and run into sizes on the order of several Gigabytes or more. It can typically take an excessive amount of time to create and upload the bundle, as well as downloading the bundle to the debugging environment.

Besides the time and processor overhead, an additional issue is that not all of the log files in the bundle are looked at by the engineer. With multi-node and multi-product solutions, this problem is aggravated even further as a proportion of the number of nodes or products from which log files need to be collected. Such solutions also inherently produce two to three time more log files owing to their operational complexities.

What is needed, therefore, is a support bundle collector service that reduces the size of support bundles in cluster networks by analyzing actual problem areas in the system.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions. Dell, EMC, Data Domain, and PowerProtect Data Manager are trademarks of Dell Technologies, Inc.

### BRIEF DESCRIPTION OF THE DRAWINGS

In the following drawings like reference numerals designate like structural elements. Although the figures depict various examples, the one or more embodiments and implementations described herein are not limited to the examples depicted in the figures.

FIG. 1 is a block diagram of illustrating a distributed system implementing support bundle collection and servicing for cluster networks, under some embodiments.

FIG. 2 illustrates a high-level overview of a network cluster using the Santorini architecture, under some embodiments.

FIG. 3 illustrates details of the services related to the data path running in Santorini cluster network, under some embodiments.

FIG. 4 illustrates the generation and transmission of support bundles between a user and vendor, under some embodiments.

FIG. 5 illustrates components of a support bundle collector service, under some embodiments.

FIG. 6 is a flowchart that illustrates a method of gathering a support bundle for Data Domain in Santorini, under some embodiments.

FIG. 7 is a list of events and items that are logged for all systems for support bundle processing, under some embodiments.

FIG. 8 is a flowchart that illustrates a method of reducing the size of support bundles, under, under some embodiments.

FIG. 9A is a flow diagram illustrating a process of using ML processes to predict problem components to reduce the size of support bundles, under some embodiment.

FIG. 9B is a flowchart illustrating a system of reducing the size of a support bundle based on predicted problem areas or components, under some embodiments.

FIG. 10 illustrates an organization of components by levels in a system, under some embodiments.

FIG. 11 illustrates an investigation of problem areas to narrow a solution for a support bundle, under an example embodiment.

FIG. 12 illustrates the threshold regions used for prediction confidence value comparisons, under some embodiments.

FIG. 13 is a block diagram of a computer system used to execute one or more software components for reducing support bundle sizes in a cluster system, under some embodiments.

### DETAILED DESCRIPTION

A detailed description of one or more embodiments is provided below along with accompanying figures that illustrate the principles of the described embodiments. While aspects of the invention are described in conjunction with such embodiments, it should be understood that it is not limited to any one embodiment. On the contrary, the scope is limited only by the claims and the invention encompasses numerous alternatives, modifications, and equivalents. For the purpose of example, numerous specific details are set forth in the following description in order to provide a thorough understanding of the described embodiments, which may be practiced according to the claims without some or all of these specific details. For the purpose of clarity, technical material that is known in the technical fields related to the embodiments has not been described in detail so that the described embodiments are not unnecessarily obscured.

It should be appreciated that the described embodiments can be implemented in numerous ways, including as a process, an apparatus, a system, a device, a method, or a computer-readable medium such as a computer-readable storage medium containing computer-readable instructions or computer program code, or as a computer program product, comprising a computer-usable medium having a computer-readable program code embodied therein. In the context of this disclosure, a computer-usable medium or computer-readable medium may be any physical medium that can contain or store the program for use by or in connection with the instruction execution system, apparatus or device. For example, the computer-readable storage medium or computer-usable medium may be, but is not limited to, a random-access memory (RAM), read-only memory (ROM), or a persistent store, such as a mass storage device, hard drives, CDROM, DVDROM, tape, erasable programmable read-only memory (EPROM or flash memory), or any magnetic, electromagnetic, optical, or electrical means or system, apparatus or device for storing information.

Alternatively, or additionally, the computer-readable storage medium or computer-usable medium may be any combination of these devices or even paper or another suitable medium upon which the program code is printed, as the program code can be electronically captured, via, for instance, optical scanning of the paper or other medium, then compiled, interpreted, or otherwise processed in a suitable manner, if necessary, and then stored in a computer memory. Applications, software programs or computer-readable instructions may be referred to as components or modules. Applications may be hardwired or hard coded in hardware or take the form of software executing on a general-purpose computer or be hardwired or hard coded in hardware such that when the software is loaded into and/or executed by the computer, the computer becomes an apparatus for practicing the invention. In this specification, these implementations, or any other form that the invention may take, may be referred to as techniques. In general, the order of the steps of disclosed processes may be altered within the scope of the described embodiments.

Embodiments are directed to a support bundle processing for cluster network file systems (e.g., Santorini) including a mechanism to collect support bundles from the network across all of the components and nodes in the cluster. A collector service component gathers the information necessary for an overall system support bundle. System and log information is collected from each component and and persistent volumes on each node while applying filter criteria. The collection is scalable by collecting from each node in parallel with a coordinator-worker design.

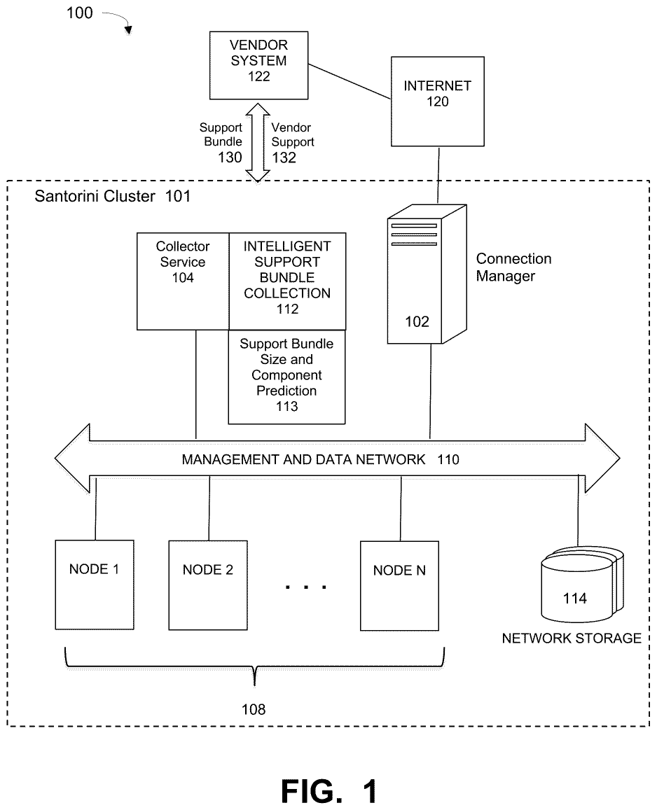

FIG. 1 is a block diagram illustrating a distributed system implementing intelligent support bundle collection for cluster networks, under some embodiments. System 100 comprises a large-scale network that includes a cluster network 101 having a number of different devices, such as server or client computers 102, nodes 108, storage devices 114, and other similar devices or computing resources. Other networks may be included in system 100 including local area network (LAN) or cloud networks, and virtual machine (VM) storage or VM clusters. These devices and network resources may be connected to a central network, such as a data and management network 110 that itself may contain a number of different computing resources (e.g., computers, interface devices, and so on). FIG. 1 is intended to be an example of a representative system implementing a distributed computing system under some embodiments, and many other topographies and combinations of network elements are also possible.

A distributed system 101 (also referred to as a cluster or clustered system), typically consists of various components (and processes) that run in different computer systems (also called nodes) that are connected to each other. These components communicate with each other over the network via messages and based on the message content, they perform certain acts like reading data from the disk into memory, writing data stored in memory to the disk, perform some computation (CPU), sending another network message to the same or a different set of components and so on. These acts, also called component actions, when executed in time order (by the associated component) in a distributed system would constitute a distributed operation.

A distributed system may comprise any practical number of compute nodes 108. For system 100, n nodes 108 denoted Node 1 to Node N are coupled to each other and a connection manager 102 through network 110. The connection manager can control automatic failover for high-availability clusters, monitor client connections and direct requests to appropriate servers, act as a proxy, prioritize connections, and other similar tasks.

In an embodiment, cluster network 101 may be implemented as a Santorini cluster that supports applications such as a data backup management application that coordinates or manages the backup of data from one or more data sources, such as other servers/clients to storage devices, such as network storage 114 and/or virtual storage devices, or other data centers. The data generated or sourced by system 100 may be stored in any number of persistent storage locations and devices, such as local client or server storage. The storage devices represent protection storage devices that serve to protect the system data through applications 104, such as a backup process that facilitates the backup of this data to the storage devices of the network, such as network storage 114, which may at least be partially implemented through storage device arrays, such as RAID (redundant array of independent disks) components. The data backup system may comprise a Data Domain system, in which case the Santorini network 101 supports various related filesystem and data managers, such as PowerProtect Data Manager (PPDM), as well as services such as ObjectScale and other services.

Cluster network 101 includes a network 110 and also provides connectivity to other systems and components, such Internet 120 connectivity. The networks may be implemented using protocols such as Transmission Control Protocol (TCP) and/or Internet Protocol (IP), well known in the relevant arts. In a cloud computing environment, the applications, servers and data are maintained and provided through a centralized cloud computing platform.

In an embodiment network 100 may be implemented to provide support for various storage architectures such as storage area network (SAN), Network-attached Storage (NAS), or Direct-attached Storage (DAS) that make use of large-scale network accessible storage devices 114, such as large capacity disk (optical or magnetic) arrays for use by a backup server, such as a server that may be running Networker or Avamar data protection software backing up to Data Domain protection storage, such as provided by Dell Technologies, Inc.

As shown in FIG. 1, network 101 includes a collector service 104 and intelligent support bundle collection process 112 that is executed by the system to manage the processing of support bundle information from and for users/customers of the system. Process 112 may be a process executed by a specialized node as a specially configured management or control node in system 100. Alternatively, it may be executed as a server process, such as by server 102 or any other server or client computer in the system. The support bundle collection process 112 works with the other components of the distributed system and may use certain services or agents that run on each compute node 108 in the distributed system, such as may be implemented as a daemon process running in each node. As generally understood, a daemon is a computer program that runs as a background process, rather than being under the direct control of an interactive user.

As shown in FIG. 1, overall system 100 includes a vendor system 122 operated by a vendor or producer of one or more of the applications, operating systems, or resources of the cluster network 101. Such a vendor may be called upon to resolve issues or provide fixes to problems encountered by users of these products. In an embodiment, support bundle information 130 is transmitted to the vendor, such as over the Internet 120 or over a local network link, and the vendor, in turn, provides back support in the form of bug fixes, patches, revisions, etc., that the user can install or execute in the cluster.

In an embodiment, cluster network 101 implements containerization technology through a Kubernetes implementation. A container is a virtualized computing environment to run an application program as a service or microservice, and are lightweight, portable data constructs that are decoupled from the underlying infrastructure. Applications are run by containers as microservices with the container orchestration service facilitating scaling and failover. For example, the container orchestration service can restart containers that fail, replace containers, kill containers that fail to respond to health checks, and will withhold advertising them to clients until they are ready to serve.

In an embodiment, system 100 uses Kubernetes as an orchestration framework for clustering the nodes 1 to N in FIG. 1. Application containerization is an operating system level virtualization method for deploying and running distributed applications without launching an entire VM for each application. Instead, multiple isolated systems are run on a single control host and access a single kernel. The application containers hold the components such as files, environment variables and libraries necessary to run the desired software to place less strain on the overall resources available. Containerization technology involves encapsulating an application in a container with its own operating environment, and the well-established Docker program deploys containers as portable, self-sufficient structures that can run on everything from physical computers to VMs, bare-metal servers, cloud clusters, and so on. The Kubernetes system manages containerized applications in a clustered environment to help manage related, distributed components across varied infrastructures. Certain applications, such as multi-sharded databases running in a Kubernetes cluster, spread data over many volumes that are accessed by multiple cluster nodes in parallel.

In Kubernetes, a pod is the smallest deployable data unit that can be created and managed. A pod is a group of one or more containers, with shared storage and resource requirements. Pods are generally ephemeral entities, and when created, are scheduled to run on a node in the cluster. The pod remains on that node until the pod finishes execution.

In an embodiment, the support bundle process 112 is used in a clustered network that implements Kubernetes clusters. One such example network is the Santorini system or architecture, though other similar systems are also possible.

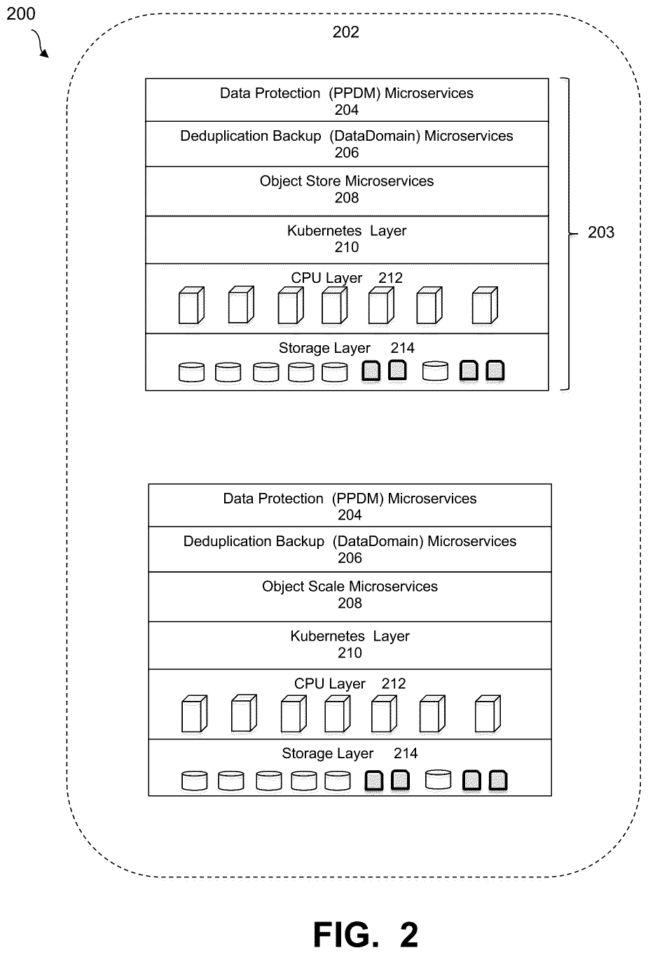

FIG. 2 illustrates a high-level overview of a network cluster using the Santorini architecture, under some embodiments. In system 200 of FIG. 2, a two-node cluster 202 is shown. Each node 203 consists of several distinct components or processing layers. For the example shown, a node includes a PowerProtect Data Manager (PPDM), or similar microservices layer 203, a Data Domain (deduplication backup) appliance microservices layer 206, an object storage (e.g., Dell ObjectScale) microservices layer 208, a Kubernetes layer 210, a processor layer 212, and a storage layer 214 including different types of storage media, such as HDD, Flash memory, SSD memory, and so on. Each of these component products consists of multiple microservices, and as more nodes are added, Santorini scales CPU, storage, RAM, and networking accordingly. Other layers can also be included, and a cluster 202 may comprise any practical number of nodes 203. The PPDM represents a cloud-native data protection manager system, and ObjectScale represents a scalable object storage manager.

As shown in FIG. 2, embodiments of the cluster network 200 through DD microservices 206 utilize Data Domain backup appliances to provide streaming deduplication, and which use the Data Domain File System (DDFS) as an inline data deduplication filesystem. As data gets written to the filesystem, DDFS creates variable sized segments and writes the unique segments to a compression region. A number of compression regions are grouped together and written as a container to disk. DDFS calculates fingerprint signatures for each segment using SHA1 algorithm. DDFS has an on-disk fingerprint index table, which maps the fingerprint to the container-ID, that has the corresponding segment data. The container has a metadata section followed by several data sections. The data sections store the compression regions; and the container metadata section stores the meta information of the container, i.e., it stores the total number of compression regions, the total number of segments, the fingerprint of each segment, and so on.

In a deduplicated filesystem that forms segments from data, these segments are uniquely identified by their key/label called a ‘fingerprint.’ Given a file offset and length, the corresponding data segment fingerprints need to be looked up. To provide faster offset to fingerprint lookup the mapping is stored in a Merkle tree format where the leaf nodes represent data segments and their fingerprints are stored in the parent nodes which are metadata segments. In a Merkle tree, every non-leaf node is labeled with the hash of the labels of its children nodes to allow efficient and secure verification of the contents of large data structures.

With respect to the directory tree structure of the data processed in system 100, various different data structures can be supported by the file system (e.g., DDFS or Santorini filesystem). A B+Tree is self-balancing tree structure and is a variant of a standard B Tree, and Each file inode is stored in the B+Tree as a data blob using the parent directory inode number and the child file inode number as the key. A B+Tree key structure composed of the parent directory inode as the primary key and child file inode as the secondary key to construct the full key. An Mtree is a tree data structure similar to a B+Tree (or R-tree), which is constructed using a metric and relies on triangle inequality for efficient range and k-nearest neighbor queries. As with other tree-based data structures, the Mtree is composed of nodes and leaves. In each node there is a data object that identifies it uniquely and a pointer to a sub-tree where its children reside. Every leaf has several data objects

A file in DDFS is represented by a Merkle tree with user data as variable sized segments at the bottom level of the tree, referred to as L0 segments. The SHA1 fingerprints of those segments are grouped together at the next higher level of the tree to form new segments, referred to as L1 segments. SHA1 fingerprints of L1 segments are grouped together as L2 segments, and this continues up to L6 which represents the entire file. The top segment of the tree is always an L6 segment, even though it may refer to any lower numbered segments. Segments above L0 are referred to as Lp chunks. The L6 segment of every file is stored in a namespace which is represented as a B+Tree. The L0 and Lp segments are written to separate containers, known as L0 and Lp containers.

A Data Domain or similar system can efficiently copy an existing file using the same underlying Merkle tree. It creates the new file with a new name, and therefore a new L6 root of the tree, but that tree then references the identical LP chunks. As this operation involves only the root of the tree, it is trivially fast and does not increase physical space in use beyond the one chunk containing the L6.

In an embodiment, the PPDM microservices layer 204 builds on the Data Domain system 206 to provide data protection capabilities for VM image backups and Kubernetes workloads.

Upon creation of an Mtree, it can identify the domain on which the Mtree is created. All namespace metadata as well as the file data and metadata associated with a Mtree is allocated from resources owned by that domain. The Mtree names as well as Mtree IDs are unique across the cluster. Santorini exposes a global namespace that is a union of all namespaces in all domains.

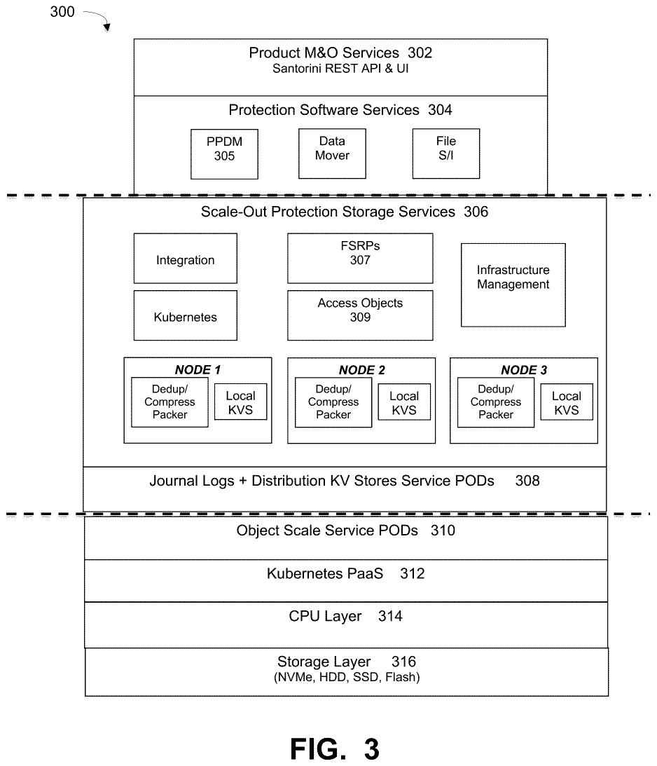

FIG. 3 illustrates details of the services related to the data path running in Santorini cluster network, under some embodiments. As shown in diagram 300, a product services layer 302 provides the necessary REST APIs and user interface utilities. The API server implements a RESTful interface, allowing many different tools and libraries can readily communicate with it. A client called kubecfg is packaged along with the server-side tools and can be used from a local computer to interact with the Kubernetes cluster.

Below layer 302, the protection software services layer 304 includes a data manager (e.g., Power Protect Data Manager, PPDM) component 305 that provides backup software functionality. Within the scale-out protection storage services layer 306, the File System Redirection Proxy (FSRP) service 307 redirects file operations in a consistent manner based on the hash of a file handle, path, or other properties to instance of the access object service 309. The access object service 309 handles protocols and a content store manager. This means that files are segmented and the Lp tree is constructed by an access object 309. The FSRP 307 redirects file system accesses in a consistent way to the access objects 309 so that any in-memory state can be reused if a file is accessed repeatedly in a short time, and it avoids taking global locks.

Also included in this layer 306 are any number of nodes (e.g., Nodes 1 to 3, as shown), each containing a dedup/compression packer and a key-value (KV) store.

As an L1 is formed, a similarity group is calculated for the L1 based on the SHA1 fingerprints of the L0 segments (or other properties). The similarity group is checked against a mapping table, which leads to consistently routing the L1 based on its similarity group to an instance of a node's dedup/compress service. If similarity groups are in a range of 0-1023, then if there are four instances of the dedup/compress service, then the instances may uniquely be responsible for the ranges 0-255, 256-511, 512-767, 768-1023, though other mappings are possible. The dedup/compress instance will deduplicate the L0 segments relative to other fingerprints within the same similarity group. Other functionality exists in the dedup/compress service such as packing segments into compression regions, containers, and blobs that will be written to an underlying object storage such as provided by the object scale service layer 310, or an object store provided by the public cloud. Other layers of system 300 include a Kubernetes PaaS (platform as software) 312, a CPU layer 314, and a storage layer 316.

Distributed key value stores 308 are also a component of Santorini and are used to hold much of the metadata such as the namespace Btree, the Lp tree, fingerprint index, and container fingerprints. These run as containers within the Santorini cluster and are stored to low latency media such as NVMe. There is also a distributed and durable log that replaces NVRAM for Santorini.

### Support Bundle Collector Service

Because of system complexity and variety of features and products, Santorini and other similar cluster systems are typically provided to users by different system providers, or vendors that provide the necessary hardware and software infrastructure necessary for users to install and deploy cluster networks in their own environment. As part of this service, vendors may also provide ongoing support in the way of bug fixes, system optimization, software upgrades/updates, configuration recommendations, and so on.

As products are developed for release and deployment, bug fixes, version iterations, and configuration support are important activities of the vendor. Such activities rely on timely and efficient interchange of information between the user and vendor to satisfactorily solve any issues that the user may encounter during and after system deployment. In an embodiment, this information is encapsulated in the form of ‘support bundles’ that comprise the relevant information and data used by the vendor to identify and solve user issues. As stated above, support bundle collection is a critical feature for Santorini, and similar systems, during both customer deployment and during product development. Support bundles are collected, transferred back to the vendor, and analyzed during debugging. Similarly, during development, engineers collect and analyze support bundles to understand problems in their code.

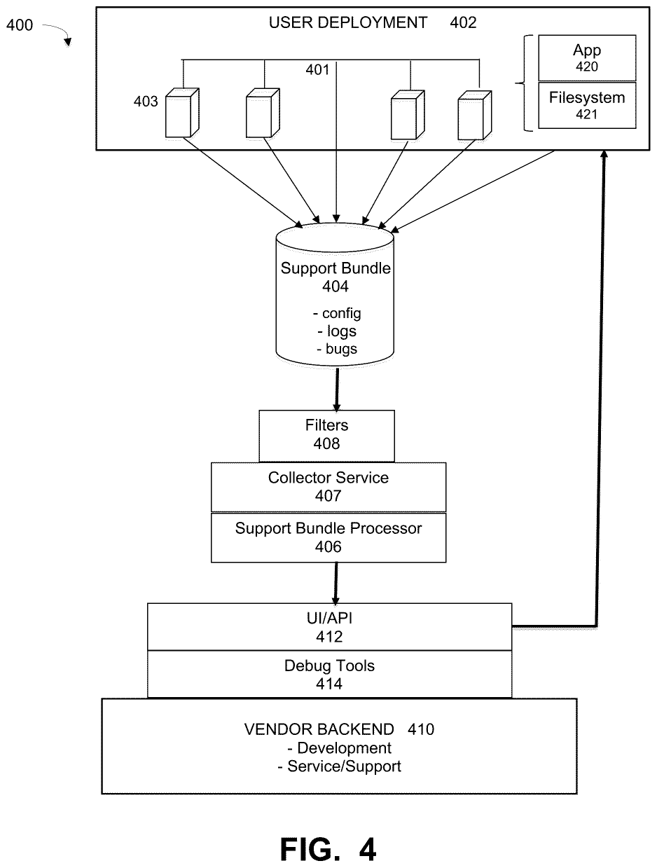

FIG. 4 illustrates the generation and transmission of support bundles between a user and vendor, under some embodiments. As shown in FIG. 4, system 400 comprises a user system 402 having a deployed cluster network including a number of individual nodes 403 coupled to one another through network links 401. User system 402 can represent any appropriate cluster network, but the description will refer to a Santorini system, although embodiments are not so limited. Such a system may be used to implement any appropriate application 420 and file system 421, though the description may specifically mention a Data Domain-based deduplication backup application and the DDFS filesystem.

During installation, deployment, and use, system 402 may encounter various issues related to software/hardware operation, configuration, application compatibility, data corruption, and so on. Any number of issues may arise, and some may be directly addressable by the system vendor. For the embodiment of system 400, the vendor operates a backend system 410 that provides development and service/support functions to both produce the components for the user and debug, support, and improve these components as they are used. For this ongoing process, the user deployment 402 produces, usually on a periodic or on-demand basis, a support bundle 404 comprising any necessary information and data necessary for the vendor backend 410 to provide appropriate fixes, updates, patches, and so on, back to the user system. In an embodiment, the support bundle includes relevant configuration for each individual node 403 and network 401, and the overall system 402. It also includes any specific problem or bug issues, and log information for relevant events and transactions.

In general, a support bundle may include all of the logs written by the various services running within the cluster, as well as topology information listing which services are running on particular nodes and their version numbers. Hardware configuration information may also be included such as drive model numbers, MAC addresses for network cards, etc. Overall system information that may be included comprise total storage capacity, capacity currently utilized, and remaining capacity. Performance statistics may include read/write latencies, read/write throughputs, replication throughput, garbage collection performance, etc. Support bundle information can also include any identified failures such as offline nodes, hardware components, or services. An overall cluster identifier will be included in the support bundle such as a product identifier number. While this information could be gathered across the entire cluster in a single support bundle, filter criteria may also be applied to limit the information gathered to particular nodes and services.

The support bundle information 404 is provided to the vendor backend 410 through a user interface or application program interface (API) component 412 that can send and receive data and commands to and from the user system 402. The vendor system may also include debug tools 414 to correct any specific issues encountered in the user system. Other vendor components include any necessary customer service (personnel) support and/or development tools to address the issues encapsulated in the support bundle 404.

In an embodiment, the support bundle 404 is collected and provided to the vendor by a support bundle processor component 406 that includes a collector service 407 that collects support bundles from the Santorini network across all of the components and nodes in the cluster. The collector service component can be configured to specifically gather the information necessary for a Data Domain (or other application) support bundle.

The collector service 407 collects system configuration and operation information from each component (node, network, application, etc.) and collects logs from persistent volumes (PVs) on each node while applying filter criteria for one or more filters 408. The filters are configured to remove unnecessary data from the user to vendor transmission in a way that does not bottleneck the data flow. The collection is scalable by collecting from each node in parallel with a coordinator-worker design.

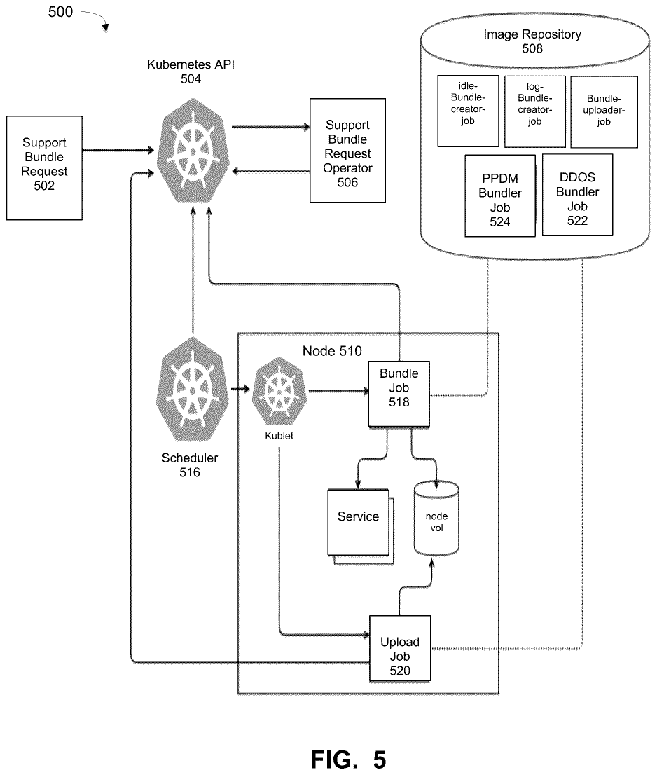

FIG. 5 illustrates components of a support bundle collector service, under some embodiments. System 500 illustrates component 406 of FIG. 4 in greater detail, and for an example embodiment of a Kubernetes-based implementation. As shown in FIG. 5, a support bundle request 502, as issued by a user or the system, triggers a Kubernetes API 504 call to trigger support bundle collection from operator 506. This call may include filter criteria to be applied to logs, such as time ranges, component types, and so on. This starts a scheduler 516 that creates a set of BundleJobs 518 for a node 510, where each job is based on a container image stored in an image repository 508. The BundleJob process 518 has the responsibility to create a support bundle for its area of responsibility and upload 520 the bundle to an interface or software component that will then transfer it to the vendor.

Different conditions can trigger or initiate a support bundle request. A typical use case is that the cluster has experienced some sort of problem that generates an alert that goes to the user and/or to the vendor. The user contacts vendor support (or support sometimes contacts the user first), and a support situation is initiated. The vendor directs the customer to generate a support bundle, which the user can do through a GUI or calling a REST API directly. The GUI has configuration options to set filter criteria and possibly set up a schedule for automatically generating a support bundle if that is deemed useful. Support bundles are usually initiated only when a problem is encountered and are typically not generated for normal cluster operation. The request may be configured to be automatically generated upon detection of a defined problem, error, or exception condition, or it can be manually triggered by the user upon such a condition or as needed/desired during cluster operation. An error condition automatically generating a support bundle request may be defined by any appropriate measurable situation, such as if capacity usage exceeds a threshold, processing bandwidth exceeds a maximum allowable percentage, and so on.

In an embodiment, the log files and various other information is gathered from individual nodes into a single support bundle by the DDOS bundler job 518. The support bundle 404 thus comprises individual sets of log and config/statistic information from each node, and which may comprise multiple files, that are then combined together into a single dataset (i.e., the support bundle), which can then be conveniently transferred to the vendor.

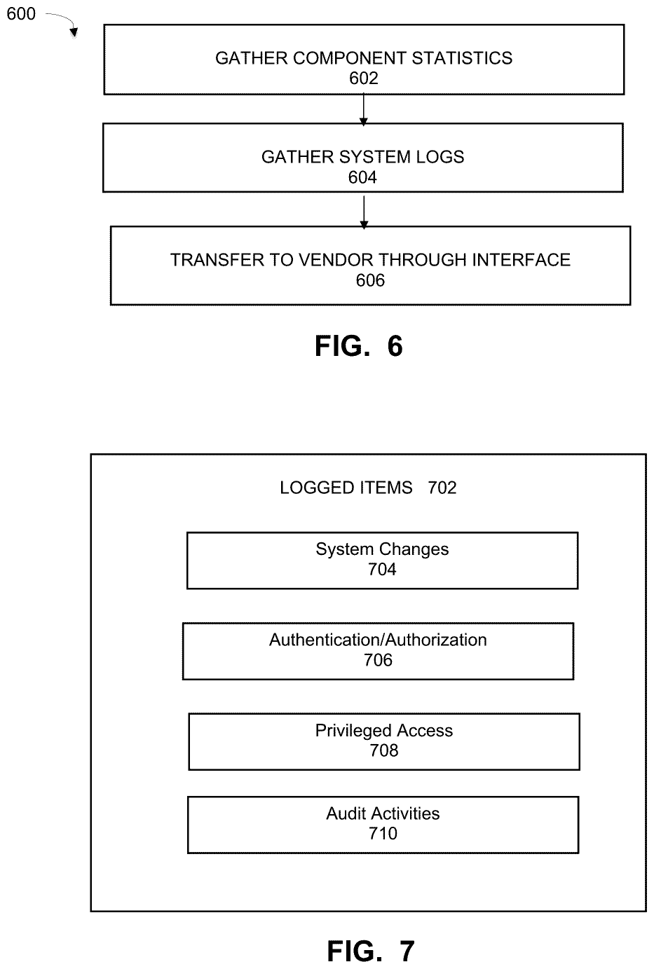

FIG. 6 is a flowchart that illustrates a method of gathering a support bundle for Data Domain in Santorini, under some embodiments. As shown in FIG. 6, process 600 involves the three main steps of gathering component statistics, 602; gathering system logs, 604; and transferring the support bundle to an interface for transfer to the vendor, 606.

In an embodiment, the component statistics gathered in step 602 comprise component statistics. Each service may be queried by the support bundle collection service, and each service will provide information to include in a support bundle. As described above, this information may include statistics about the service such as counters, performance measurements, latencies, and other details that will allow support and engineers to understand its internal workings. Any error situation identified by the service can also be included in this information.

In a cluster network, each component/product has many services, and often many different instances of each service. Services may be started, stopped, and re-started, even on different nodes. Logging the execution and issue of processes across all of the components is necessary to diagnose any issues in the system, and logs should be available across container failures. With respect to FIG. 2, generally the microservices layers 204, 206, and 208 perform the logging functions.

As shown in FIG. 6, step 604 comprises gathering system logs for the support bundle. In general, the following events are logged for all systems. FIG. 7 lists the events and items 702 that are logged for all systems. As shown in FIG. 7, the logged items 702 include system changes 704, which can comprise component availability state changes, such as nodes or processes shutting down; component failures and errors, such as device failures and recoverable memory errors; configuration changes, such as adding a device, installing an application or enabling a service; or changes to source code in production or configuration changes in a production system; and other similar system changes.

Logged items also include authentication and authorization events 706, such as authentication failures (e.g., login failures and account lockouts); failed accesses, such as insufficient permissions to access a database or transaction; or identity and access provisioning activities (e.g., creating new accounts, granting new permissions or changing existing permissions); and other similar activities. Privileged access events 708 can include access to privileged functions (e.g., using a super user level access (e.g., Linux sudo), running the administrative console or logging in as a normal user account; or all actions taken by any individual with root or administrative privileges. The audit-related activities 710 can include changing the event logging configuration or deleting event logs, or audit log failure, among others. FIG. 7 is provided for purposes of illustration and other items may also be logged as needed.

### Support Bundle Size Reduction

As stated above, the present size of support bundles can be large enough to impose excessive amounts of space and processor overheads on the overall system. As shown in FIG. 1, embodiments of system 100 include an intelligent support bundle collection processing component that significantly reduces the effective size of support bundles, such as at least by 50%. Through this component, the system is configured select a subset of log files to be collected in the support bundle based on the problem faced by the end-user.

Through component 100, system 112 reduces the size of a support bundle by intelligently selecting a subset of log files to be collected based on problems faced by the user. This is performed by a support bundle size calculation based on a component prediction process 113.

Using process 113, the user is prompted to enter a description of the problem and machine learning (ML) models are used to identify the problem component. The error messages in the log files are analyzed to find and provide an appropriate context for the problem and to establish a time window for the relevant logs. Component 112 can also collect and use additional information and diagnostic tools within the system to identify appropriate log files to include in the subset of log files.

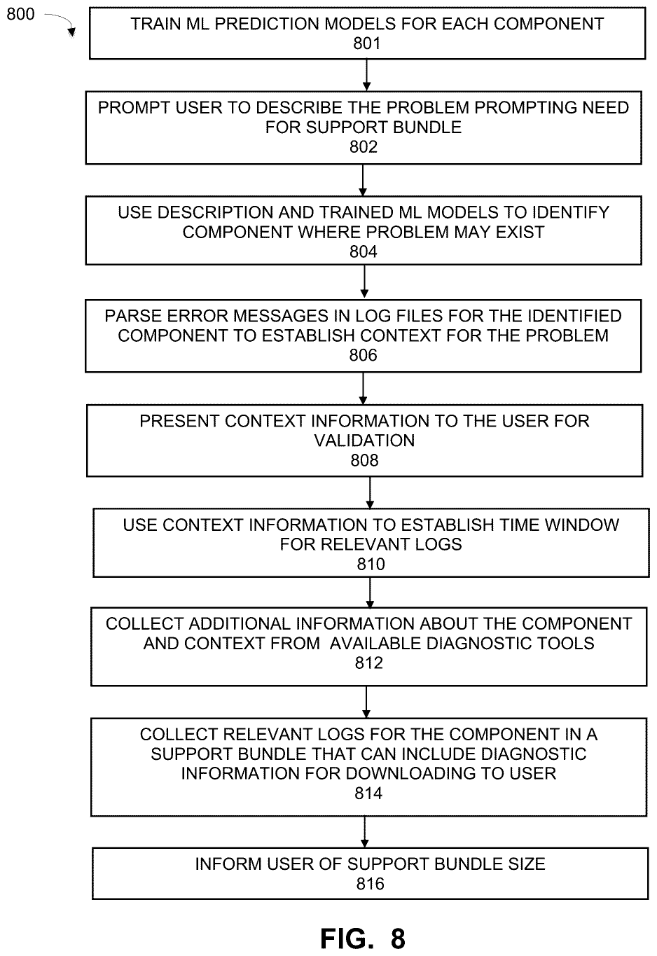

FIG. 8 is a flowchart that illustrates a method of reducing the size of support bundles, under some embodiments. The process employs certain ML models to identify or otherwise derive the component within the product in which the problem may exist. As an initial step, 801, ML models are trained for each component for the prediction process. Upon receiving indication of any problem in the system, such as by a user complaint or customer support ticket, the user is asked to provide a description the problem (such as through simple text entered through a user interface), 802. This generally prompts the need to download the support bundle. The system then uses this description, and employs the trained ML models to identify the component within the product in which the problem may exist through a prediction generated by application of the model, 804.

In an embodiment, the models for problematic component prediction may comprise generic ML algorithms, such as BaggingClassifier, BERT, RandomForester, such as provided by Python packages, or similar models.

In step 806, the system parses error messages in log files for the identified component to establish a context for the problem, such as a problematic client, failed backup job, and so on, 806. This information is then presented to the end-user for confirmation or validation, 808. This information is used to establish a conditions or events surrounding the problem, such as time windows, events, components, and so on, that would help identify relevant logs for the component, 810.

The system also collects additional information pertaining to the identified component and the problem context by executing diagnostic tools already available in the product, 812. This diagnostic information, along with the contextual information is used to identify relevant logs for the component for collection into a support bundle, which can then be downloaded to the user, 814. The system report the constituent log files and size of the compressed support bundle to the user, 816. The automatic use of diagnostic tools 906 based on the context information saves the need for communication back and forth with the technical support staff asking the user to run these tools after the support request is raised.

The process of FIG. 8 thus generates a support bundle that includes log information for the specific component that is predicted to be the source of the problem, and further concentrates on log files related by context to the specific problem.

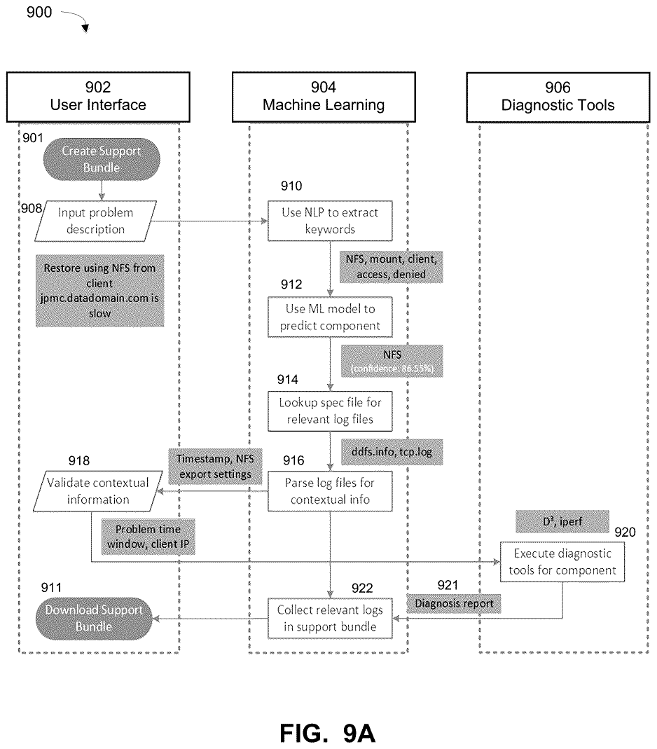

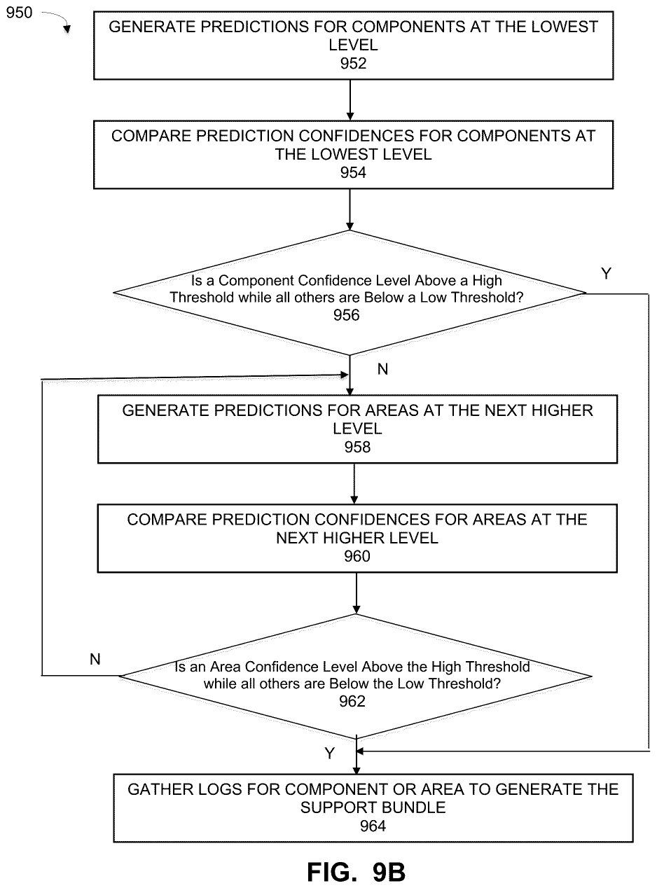

FIG. 9A is a flow diagram illustrating a process of using ML processes to predict problem components to reduce the size of support bundles, under some embodiment. FIG. 9A illustrates process flows among a user interface 902 taking input from a user, a machine learning component 904, and diagnostic tools 906. When the user notices an anomaly or a problem and decides to report that to appropriate technical support personnel, they can also use additional features to briefly describe the problem. The problem description is further passed to the pre-trained ML model 904.

The process flow 900 of FIG. 9A starts with the system creating a support bundle 901 that is ultimately downloaded back through the user interface 902 as downloaded support bundle 911 after being processed by components 904 and 906 to reduce the overall size of the original support bundle 901.

The user is prompted to provide a textual description of the problem that prompted creation of the support bundle. This input 908 is provided through the user interface 902 and can be of any appropriate format and type, such as simple English (or other language) sentences, pre-defined text elements, and so on. In an embodiment, the user can open a wizard in the UI 902 to create an intelligent support bundle and describes the problem in a few text sentences. The ML process 904 uses Natural Language Processing (NLP) 910 to decipher the user input. The NLP component can utilize any appropriate language recognition and translation processes to interpret the problem description based on input language, format, text conventions, and so on.

The ML component 904 uses the NLP component to extract keywords that describe or relate to identifiable system elements and problems, such as “NFS,” “mount,” “client,” “access,” “denied,” and so on. Using these keywords, an ML model 912 is then used to predict the closest component where the problem may exist.

For the prediction process, the system defines an threshold or minimum acceptable level of confidence, such as 85% or similar. Once the prediction shows and acceptable level of confidence score, the solution will look for the SPEC file (or similar data element) 914 that describes the log files that should be collected. The example of FIG. 9A shows a case where the NFS is found to present a problem with a confidence of 86.55%, and that the log files include ddfs.info and tcp.log files, among possible others.

The ML process 904 then parses the identified log files to find any relevant contextual information and gather additional troubleshooting information, 916. The parsed log files may yield textual information that is then transmitted back to the user through user interface 902 who can then validate the textual information, 918. Examples of such contextual information can include timestamps, NFS export settings, and so on. The validation could consist of the user verifying that timing was incorrect or client IP addresses were incorrect, and so on. This information is then used to trigger the application of any appropriate diagnostic tools 906, which are then executed for the predicted component, 920. The diagnostic tools 906 generate a diagnosis report 921 for transmission back to the ML component 904.

The ML component 904 then combines this information together to generate a support bundle, 922, which is then sent through the user interface 902 to comprise the downloaded support bundle 911. Since the log files and additional information that are collected and downloaded is only used for very specific predicted component (e.g., NFS), the support bundle size can be greatly reduced, such as by up to 75% in size over support bundles that include log files for all components (e.g., file systems, servers, clients, network links, etc.).

Overall, the process of FIG. 9A involves the user providing a description of the problem in a few text sentences through UI 902, after which the problematic component is predicted by ML process 904 and contextual information is presented to the user for validation. Additional automated diagnostic tools 906 are executed in the background and a subset of log files are selected to be collected in the support bundle. The user is informed about the selected files and the total estimated compressed size of the bundle.

As described above, embodiments of system 100 and process 900 include an ML model (904) for problematic component prediction given a textual description of the problem as an input. Models are provided for each component or sub-area of the system. These models can be trained using historical data from customer found defects using bug title and description, along with the engineer-assigned product component for supervised learning. Further contextual information is also derived from sets of logs.

In an embodiment, the prediction process breaks the problem to break into a number of separate sub-problem areas in order to drill down through various component levels and improve the prediction confidence at each level. The components (or entities) in a system are generally organized in order of individual components at a lowest level to groups of components at a next higher level, to groups of component groups at a yet next higher level, and so on up to the system level. This can be pictured as a company org chart with workers at the lowest level grouped into departments grouped into divisions, etc., or a filesystem having files at a lowest level grouped into sub-directories grouped into directories up to a namespace, etc., or any other similar hierarchically organized system. Problems encountered at the lowest level can be linked to a particular component with some degree of confidence give the prediction provided by the ML model. If the confidence is not high enough relative to other components at the same level, the prediction confidence at the next higher level (where that component is grouped with other components) can then be checked. This should yield a higher confidence level, and so on up to the highest or overall system level, which should ostensibly has a prediction confidence of 100% since it contains all the components including any problematic components.

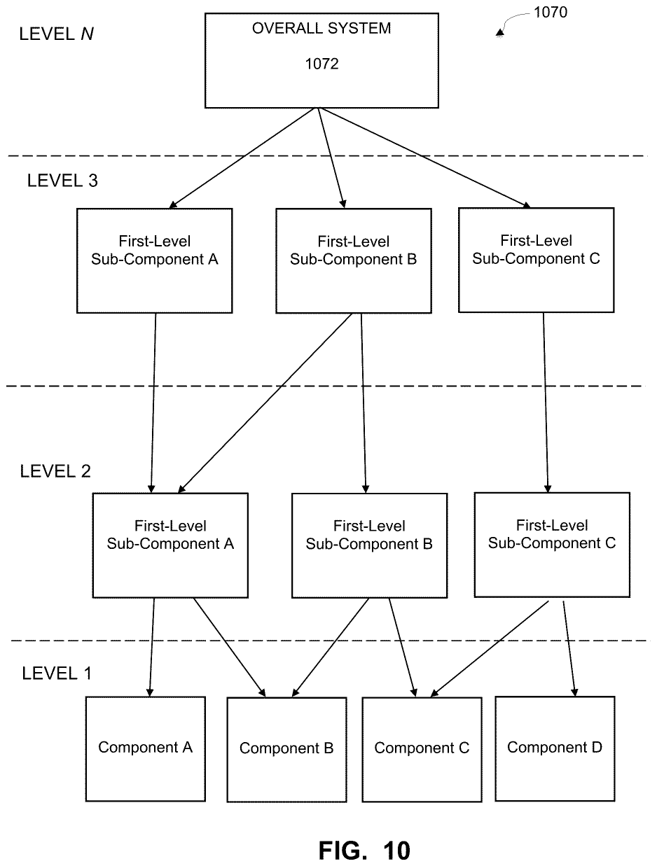

FIG. 9B is a flowchart illustrating a system of reducing the size of a support bundle based on predicted problem areas or components, under some embodiments. Process 950 begins by generating predictions for each component at the lowest level, 952, such as for a system illustrated in FIG. 10. As shown in FIG. 9A, this involves applying the ML model generated for a component to each component at that level. This yields a respective confidence value for each component, which can then be used to compare each component's confidence value with all of the other component confidences in that level, 954.

In step 956, it is determined whether or not the prediction confidence of any one component is sufficiently enough high, as set by a high threshold value (e.g., 85%), to judge that component as being most likely to be the cause of the reported problem. At the same time, the confidences of the other components must be below a low threshold value (e.g., 30%) to judge that those components are likely not the cause of the problem. If this is the case, then the component with the high enough confidence is identified as the problem, and log data for that component are gathered for the support bundle, 964. At this component level, the support bundle should be relatively small in size since the log files pertain to that one component only, as opposed to all the components in the level.

If, in step 956, it is determined that there is no one component that has a sufficiently high confidence and/or there are other components that are not of sufficiently low confidence, the process generates predictions for areas at a next higher level, that is, one in which the components are grouped into different areas or sub-groups, 958. The prediction confidences for this next level of areas are then compared with one another, 960. It is then determined, 962, whether or not the prediction confidence of any one area is sufficiently enough high, as set by the same (or a different) high threshold value (e.g., 85% or 80%), to judge that area as being most likely to be the cause of the reported problem. At the same time, the confidences of the other areas must be below the same (or different) low threshold value (e.g., 30% or 25%) to judge that those areas are likely not the cause of the problem. If this is the case, then the area with the high enough confidence is identified as the problem, and log data for the components in that area are gathered for the support bundle, 964. At this area level, the support bundle should still be relatively small in size (though bigger than at the individual component level) since the log files pertain to some components only, as opposed to all the components in the level.

If, in step 962, it is determined that there is no one area that has a sufficiently high confidence and/or there are other areas that are not of sufficiently low confidence, the process generates predictions for areas at a yet next higher level, which could be a grouping of component groups, or the system as a whole, and so on. This process continues until the highest level is reached, at which point the prediction confidence should be 100%, and therefore definitely identified as the problem, and the logs for all components will be gathered into the support bundle, which will then be of its maximum size. Alternatively, a cut-off point can be defined in which the high and low threshold values are relaxed enough to allow components or areas to be identified earlier.

FIG. 9B illustrates a sequential and iterative process of identifying problem components based on prediction confidences on a level-by-level basis. FIG. 10 illustrates an organization of components by levels in a system, under some embodiments. As shown in FIG. 10, a typical computer system 1070 comprises number of operational levels under the overall system itself 1072, which could be a server computer, namespace, root directory, and so on. This can represent the highest level of the network including all of the computer infrastructure (servers, clients, nodes, storage devices, sub-directories, etc.), network infrastructure (connections, links, interfaces, routers, etc.), software (file systems, applications, programs, etc.), and so on. The overall system thus comprises many individual components that may be organized in various hierarchical or separate levels, such as levels 1, 2, 3 to N, as shown, where N may be any appropriate number for a given system scale, composition, and configuration. For an organization where the top or overall system is the highest level, N, the lowest level may be denoted level 1, and typically comprises the individual components, such as individual computers, storage devices, network links, software programs, files, and so on. These components may be grouped into, controlled by, or logically/physically associated with any number of second level components, which in turn may be similarly associated with any number of third level components, and so on, all the way up to the overall system level 1072.

In an embodiment, the vertical organization of a system into different levels of system 1050 is used to narrow the solution-finding process 800 during the hierarchical component identification step 804. For this embodiment, a structured approach is used to develop multiple ML models that generate predictions of problematic components at each level from highest to lowest until a minimum or satisfactory confidence level is reached to identify a particular component or system area that most likely caused the problem. That is, a prediction above a certain high threshold value or percentage, such as an 80% chance that a particular level or a component within that level caused the problem.

In general, the highest level will not yield any satisfactory prediction since and all components within the system may be the source of the problem. Conversely, analyzing at the lowest level may provide the highest degree of confidence since log data for each component in the system is investigated, but this can require too much processing and time. The organization and analysis of the components within hierarchical levels allows the process to perform the analysis in way that balances processing overhead versus predictability confidence.

In an embodiment, the sequential and hierarchical prediction process goes from the lower level components (e.g., from level 1) successively through the higher level components up to level N. A prediction at a lower level yields a lower chance of identifying the problem with a high enough degree of confidence, but would yield a smaller support bundle size, while a satisfactory prediction confidence at higher level would increase the support bundle size.

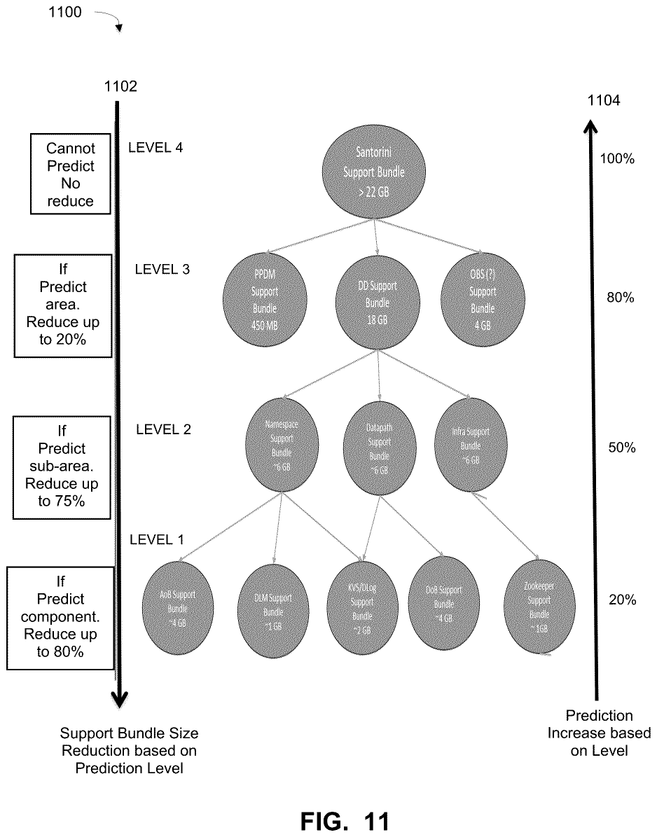

FIG. 11 illustrates an investigation of problem areas to narrow a solution for a support bundle, under an example embodiment. Specifically, FIG. 11 illustrates consecutive investigation of problem areas in a Santorini-based Data Domain system. In general, Santorini is a scale-out software solution that comprises a number of different components such as deduplication backup modules (e.g., PPDM), object storage, AOB, DOB, distribution logs, KVS, and so on. These can each be considered the lowest or Level 1 components.

As shown in FIG. 11, system 1100 is based on a hierarchical set of levels (as in FIG. 10), wherein specific components can be grouped into different areas within the different levels 1-4. In such a system, a problem reported as a Santorini bug could pertain any component within the overall system at level 4 down to the level 1 sub-components. As shown in FIG. 11, axis 1102 represents the reduction in support bundle size based on prediction analysis performed for the components in each respective level.

The levels of predictions can be defined such for the Santorini DDFS system 1100 of FIG. 11 as outlined below:
Level 1—Prediction for AoB, DoB, Cloud, Infra, Manageability, Networking;
Level 2—Prediction for Namespace, Datapath, Infrastructure;
Level 3—Prediction for PPDM, PPDD, OBS;
Level 4—Santorini (this is default and will always collect full support bundle).

As shown in the example of FIG. 11, each component or area (groups of components) has a corresponding example size for its support bundle. For example, 450 MB for the PPDM support bundle, 18 GB for the DD support bundle, and so on. The support bundle size for the Santorini system itself (at level 4) is of the maximum size, such as on the order of 22 GB. If the problem is predicted only at this level (level 4) no reduction in support bundle size is possible, since the logs for all the components will be gathered, and no any component can be eliminated through prediction of the most likely component or components.

The level 3 components in FIG. 11 represent the three main Santorini product areas of PPDM, DD, and OBS (Object Store). Identifying a problem in these areas of level 3 yields a reduction of the support bundle size by 20% (i.e., from 22 GB down to 18 GB or lower). Identifying a problem at the next level, level 2, which comprises sub-areas of the products, including, under the Data Domain (DD) area, Namespace, Datapath, and Infrastructure, among others, yields a reduction of the support bundle size by 75% (i.e., 22 GB down to 6 GB). Identifying a problem the lowest (component) level, level 1 might yield a reduction of the support bundle by 80% (i.e., from 22 GB down to 4 GB or lower).

As shown in diagram 950, a structured approach is used to apply multiple ML models that generate predictions of problem components at each level. These prediction scores generate corresponding confidence levels of problem identification that is then used to gather support bundles for the most relevant components or sub-components.

The prediction confidence corresponds to a proportional reduction of support bundle size. As shown in FIG. 11, the axis 1102 represents the reduction of support bundle size based on prediction level. Thus working down from the most general system (Level 5) where there is no prediction since all components are included, there would be no reduction in support bundle size. For the next level (Level 4) there is some prediction possible so the support bundle size may be reduced by up to 20%. For the next level (Level 3) there is greater prediction of problematic components possible so the support bundle size may be reduced by up to 75%, and For the near lowest level (Level 5) there is even more prediction possible so the support bundle size may be reduced by up to 80%.

The percentage reduction in support bundle size may be expressed as a percentage, as shown, or as a different metric measure. The percentage reduction is proportional to the prediction percentage, and may be the same, or relatively the same. FIG. 11 also shows an axis 1104 of the increase in the chance of accurately predicting a problem component as higher level components are checked. For example, there may only be a 20% chance of finding a problem in level 1, while going up a level to level 2 may increase that chance to 50%. Likewise going up to level 3 may increase this to 80% while, the system level would yield 100% chance of containing the problem component.

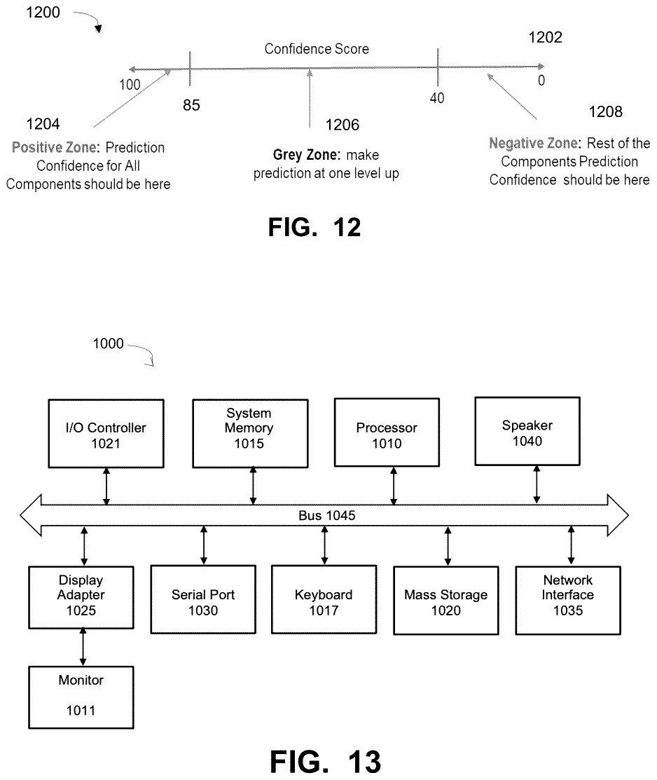

As shown in the flowchart 950 of FIG. 9B, the process of identifying a level containing a most likely problematic component involves comparing the prediction confidences of each component with each other within a level to identify a problematic component within an acceptable threshold. FIG. 12 illustrates the threshold regions used for prediction confidence value comparisons, under some embodiments. Diagram 1200 of FIG. 12 illustrates an axis 1202 that displays a confidence score along an axis from 100 down to zero. The confidence score along this axis is divided into three regions or ‘zones.’ The positive zone 1204 indicates a confidence of a prediction is above a defined threshold, such as 85%. The grey zone 1206 is an intermediate region that indicates that the confidence of the prediction is of an indeterminate value (e.g., 85% and 40%) and that analysis at a next higher level is required, and the negative zone 1208 represents a region where the confidence of prediction of a component being the problem is below the defined lower threshold (e.g., 40%).

In an embodiment, the analysis process looks at the confidence level of a component which is predicted to be in the positive zone, and at the same time, it makes sure that the prediction confidence for all other components is in the negative zone. If there are any components with a prediction confidence in the grey zone 1206, the next higher level is analyzed and predictions at that level are then obtained.

As shown in FIG. 9B, determination steps 956 and 962 check whether or not a component confidence level is in the positive zone, while all other components in that level are in the negative zone. If so, that component is identified as the problem and the logs for that component are used for the support bundle. If not, the process proceeds through the next higher levels.

As mentioned above, the confidence score for the prediction increases as the component level goes from high (system) level to lower (sub-component) and low (component) levels. Predicting a problem component at only a high or higher level results in a larger support bundle size, since the support bundle necessarily include many components that are likely not the problem. Likewise, predicting a problematic component at successively lower levels reduces the support bundle size accordingly as the number of log files is lessened for the fewer components.

FIG. 12 is provided for purposes of illustration only, and other threshold values and zone definitions may also be used.

For the embodiment of FIG. 10 and the example embodiment of FIG. 11, levels for predictions were created based on supervised category creation. These can also be neighboring areas, and such areas can be analyzed independently as described.

Embodiments of the support bundle collection system derive new categorical features for problem area prediction, and construct a tree-like ML-based prediction model to significantly reduce the effective size of support bundles for cluster networks.

Certain enhancements can also be provided to improve the accuracy of the prediction. These include training the ML models using actual bug and triage information, and enhancing the text input and character recognition in the UI. For example, when a user describes the problem, a static script will also gather and search for specific strings in the log files. For example, strings such as: PANIC or CRITICAL, or other defined strings. A few sets of words will be pre-defined for this search operation. The resultant output will be embedded along with the description provided by the user for a particular issue to enhance the prediction accuracy and confidence.

Embodiments of the processes and techniques described above can be implemented on any appropriate backup system operating environment or file system, or network server system. Such embodiments may include other or alternative data structures or definitions as needed or appropriate. The processes described herein may be implemented as computer programs executed in a computer or networked processing device and may be written in any appropriate language using any appropriate software routines. For purposes of illustration, certain programming examples are provided herein, but are not intended to limit any possible embodiments of their respective processes.

The network of FIG. 1 may comprise any number of individual client-server networks coupled over the Internet or similar large-scale network or portion thereof. Each node in the network(s) comprises a computing device capable of executing software code to perform the processing steps described herein.

FIG. 13 is a block diagram of a computer system used to execute one or more software components of a support bundle space reduction mechanism for distributed systems, under some embodiments. The computer system 1000 includes a monitor 1011, keyboard 1017, and mass storage devices 1020. Computer system 1000 further includes subsystems such as central processor 1010, system memory 1015, input/output (I/O) controller 1021, display adapter 1025, serial or universal serial bus (USB) port 1030, network interface 1035, and speaker 1040. The system may also be used with computer systems with additional or fewer subsystems. For example, a computer system could include more than one processor 1010 (i.e., a multiprocessor system) or a system may include a cache memory.

Arrows such as 1045 represent the system bus architecture of computer system 1000. However, these arrows are illustrative of any interconnection scheme serving to link the subsystems. For example, speaker 1040 could be connected to the other subsystems through a port or have an internal direct connection to central processor 1010. The processor may include multiple processors or a multicore processor, which may permit parallel processing of information. Computer system 1000 is an example of a computer system suitable for use with the present system. Other configurations of subsystems suitable for use with the present invention will be readily apparent to one of ordinary skill in the art.

Computer software products may be written in any of various suitable programming languages. The computer software product may be an independent application with data input and data display modules. Alternatively, the computer software products may be classes that may be instantiated as distributed objects. The computer software products may also be component software. An operating system for the system may be one of the Microsoft Windows®. family of systems (e.g., Windows Server), Linux, Mac™ OS X, IRIX32, or IRIX64. Other operating systems may be used.

Although certain embodiments have been described and illustrated with respect to certain example network topographies and node names and configurations, it should be understood that embodiments are not so limited, and any practical network topography is possible, and node names and configurations may be used.

Embodiments may be applied to data, storage, industrial networks, and the like, in any scale of physical, virtual or hybrid physical/virtual network, such as a very large-scale wide area network (WAN), metropolitan area network (MAN), or cloud-based network system, however, those skilled in the art will appreciate that embodiments are not limited thereto, and may include smaller-scale networks, such as LANs (local area networks). Thus, aspects of the one or more embodiments described herein may be implemented on one or more computers executing software instructions, and the computers may be networked in a client-server arrangement or similar distributed computer network. The network may comprise any number of server and client computers and storage devices, along with virtual data centers (vCenters) including multiple virtual machines. The network provides connectivity to the various systems, components, and resources, and may be implemented using protocols such as Transmission Control Protocol (TCP) and/or Internet Protocol (IP), well known in the relevant arts. In a distributed network environment, the network may represent a cloud-based network environment in which applications, servers and data are maintained and provided through a centralized cloud-computing platform.

Some embodiments of the invention involve data processing, database management, and/or automated backup/recovery techniques using one or more applications in a distributed system, such as a very large-scale wide area network (WAN), metropolitan area network (MAN), or cloud based network system, however, those skilled in the art will appreciate that embodiments are not limited thereto, and may include smaller-scale networks, such as LANs (local area networks). Thus, aspects of the one or more embodiments described herein may be implemented on one or more computers executing software instructions, and the computers may be networked in a client-server arrangement or similar distributed computer network.

Although embodiments are described and illustrated with respect to certain example implementations, platforms, and applications, it should be noted that embodiments are not so limited, and any appropriate network supporting or executing any application may utilize aspects of the backup management process described herein. Furthermore, network environment 100 may be of any practical scale depending on the number of devices, components, interfaces, etc. as represented by the server/clients and other elements of the network. For example, network environment 100 may include various different resources such as WAN/LAN networks and cloud networks 102 are coupled to other resources through a central network 110.

For the sake of clarity, the processes and methods herein have been illustrated with a specific flow, but it should be understood that other sequences may be possible and that some may be performed in parallel, without departing from the spirit of the invention. Additionally, steps may be subdivided or combined. As disclosed herein, software written in accordance with the present invention may be stored in some form of computer-readable medium, such as memory or CD-ROM, or transmitted over a network, and executed by a processor. More than one computer may be used, such as by using multiple computers in a parallel or load-sharing arrangement or distributing tasks across multiple computers such that, as a whole, they perform the functions of the components identified herein; i.e., they take the place of a single computer. Various functions described above may be performed by a single process or groups of processes, on a single computer or distributed over several computers. Processes may invoke other processes to handle certain tasks. A single storage device may be used, or several may be used to take the place of a single storage device.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

All references cited herein are intended to be incorporated by reference. While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method of reducing a size of a support bundle for a cluster network system having a plurality of components arranged in a hierarchical set of levels, comprising:
prompting a user to input a description of a problem initiating generation of a support bundle;
applying machine learning (ML) models to each component in a first level of the set of levels to predict a respective chance of the component causing the problem;
comparing a respective prediction of each component with other components in the first level;
determining if a component has a prediction confidence higher than a high threshold and if other components in the first level all have a prediction confidence lower than a low threshold; and if so:
identifying the component as a predicted component, gathering log files for the predicted component to generate the support bundle, otherwise proceeding to a next higher level of the set of levels to generate and compare prediction values for components in the next higher level until a single component has the prediction confidence higher than the high threshold while all remaining components have respective prediction confidences lower than the low threshold.

2. The method of claim 1 wherein the description is entered by the user in textual language through a user interface, the method further comprising applying natural language processing (NLP) functions to the entered description to translate the textual language to a form recognizable by the ML models.

3. The method of claim 1 wherein the system comprises the plurality of components organized into one or more levels from a highest level for the system to a lowest level for individual components, and wherein each level comprises sub-components, and wherein the system is hierarchically comprised of lower level sub-components down to the lowest level.

4. The method of claim 3 further comprising assigning a confidence level to a prediction of the predicted component along a percentage scale from 0 to 100, and wherein the high threshold is on the order of 80% and the low threshold is on the order of 40%.

5. The method of claim 4 wherein a size of a support bundle is maximum for the highest level comprising the system as a whole, and the prediction confidence is proportional to an increase in levels from the lowest level to the highest level.

6. The method of claim 1 wherein the log files comprise information related to at least one of: component availability state changes, component failures and errors, configuration changes, changes to source code in production, or configuration changes in a production system.

7. The method of claim 6 further comprising:
parsing error messages in one or more log files for the predicted component to establish a system context for the problem; validating the system context to identify relevant log entries for the log; and
collecting the identified relevant log entries in the support bundle.

8. The method of claim 1 wherein the high threshold and low threshold are percentage values defined by one of user input or system default settings.

9. The method of claim 1 wherein the clustered network comprises a plurality of networked nodes using a Santorini filesystem network processing containerized data utilizing a Kubernetes-based framework, and further wherein the cluster network comprises part of a deduplication backup system performing backup and restore operations for the nodes.

10. A method of reducing a size of a support bundle for a cluster network system, comprising:
organizing the system into a hierarchical plurality of levels from a highest level of the system itself down to a lowest level of constituent components, wherein constituent components are associated with sub-components of a next higher level, and sub-components of the next higher level are associated with further sub-components of a yet next higher level, up to the highest level of the system itself;
receiving, from a user, a description of a problem causing generation of the support bundle;
first determining probabilities that respective components within a level caused the problem as a problematic component based on the description and derived context information;
second determining whether a probability a component of the respective components exceeds a high threshold, and if remaining components of the respective components all have respective probabilities lower than a low threshold;
processing all components in each level until a single component has a probability above the high threshold and all the remaining components have the respective probabilities below the low threshold; and
gathering logs for the single component to generate the support bundle.

11. The method of claim 10 further comprising assigning a confidence level to a prediction of the single component along a percentage scale from 0 to 100, and wherein the high threshold is on the order of 80% and the low threshold is on the order of 40%.

12. The method of claim 11 wherein a size of the support bundle is maximum for the highest level comprising the system as a whole, and the probability is proportional to a percentage reduction in size of the support bundle from the maximum.

13. The method of claim 10 wherein the description is entered by the user in textual language through a user interface, the method further comprising applying natural language processing (NLP) functions to the entered description to translate the textual language to a form recognizable by the one or more ML models.

14. The method of claim 10 wherein the log files comprise logs including information related to at least one of: component availability state changes, component failures and errors, configuration changes, changes to source code in production, or configuration changes in a production system.

15. The method of claim 10 wherein the clustered network comprises a plurality of networked nodes using a Santorini filesystem network processing containerized data utilizing a Kubernetes-based framework, and further wherein the cluster network comprises part of a deduplication backup system performing backup and restore operations for the nodes.

16. The method of claim 10 wherein the high threshold and low threshold are percentage values defined by one of user input or system default settings.

17. A system of reducing a size of a support bundle for a cluster network system having a plurality of components arranged in a hierarchy of levels, comprising:
a hardware-based user interface component receiving input from a user including a description of a problem initiating generation of the support bundle;
a machine learning (ML) component applying respective ML models for each component to the description to predict a component of the cluster network system as a most likely cause of the problem within a level of the hierarchy;
a first component comparing a respective prediction of each component with other components in a first level of the hierarchy;
a comparator determining if a component has a prediction confidence higher than a high threshold and if other components in the first level all have a prediction confidence lower than a low threshold; and if so:
identifying the component as a predicted component, gathering log files for the predicted component to generate the support bundle, otherwise proceeding to a next higher level of the set of levels to generate and compare prediction values for components in the next higher level until a single component has the prediction confidence higher than the high threshold while all remaining components have respective prediction confidences lower than the low threshold.

18. The system of claim 17 further comprising a second component assigning a confidence level to a prediction of the predicted component along a percentage scale from 0 to 100, and wherein the high threshold is on the order of 80% and the low threshold is on the order of 40%.

19. The system of claim 18 wherein a size of a support bundle is maximum for the highest level comprising the system as a whole, and the prediction confidence is proportional to an increase in levels from the lowest level to the highest level.

20. The system of claim 17 wherein the logs comprise information related to at least one of:
component availability state changes, component failures and errors, configuration changes, changes to source code in production, or configuration changes in a production system, and further wherein the clustered network comprises a Santorini filesystem network processing containerized data utilizing a Kubernetes-based framework, and wherein the cluster network comprises part of a deduplication backup system performing backup and restore operations for the nodes.
